(19) United States
(12) Patent Application Publication
(10) Pub. No.: US 2015/0143292 A1
(43) Pub. Date: May 21, 2015

(54) Method and Device for Processing Application of Mobile Terminal

(71) Applicant: HUAWEI TECHNOLOGIES CO., LTD., Shenzhen (CN)

(72) Inventors: Umesh Srinivasan, Bangalore (IN); Himangshu Lahkar, Bangalore (IN)

(21) Appl. No.: 14/586,373

(22) Filed: Dec. 30, 2014

Related U.S. Application Data
(63) Continuation of application No. PCT/CN2014/091666, filed on Nov. 19, 2014.

(30) Foreign Application Priority Data
Nov. 19, 2013 (IN) IN5328/CHE/2013

(51) Int. Cl. G06F 17/27; G06F 3/0484; G06F 17/22; G06F 3/0482

(52) U.S. Cl. CPC G06F 17/2715; G06F 3/0482; G06F 3/04842; G06F 17/2288
USPC 715/812

(57) ABSTRACT

A method and a device for processing an application of a mobile terminal are provided. The method for processing the application of the mobile terminal includes: generating a display interface, where the display interface includes a user habit list, the user habit list includes at least one user habit option, and the user habit option includes application information and content information; receiving a first operating command input by a user, and determining the user habit option corresponding to the first operating command; triggering an application indicated by the application information of the user habit option which corresponds to the first operating command to parse the content information of the user habit option which corresponds to the first operating command, so as to make the application run content corresponding to the content information.

This application is a continuation of International Application No. PCT/CN2014/091666, filed on Nov. 19, 2014, which claims priority to India Patent Application No. IN5328/CHE/2013, filed on Nov. 19, 2013, both of which are hereby incorporated by reference in their entireties.

### TECHNICAL FIELD

The present invention relates to the field of mobile terminal technology, and in particular, to a method and a device for processing an application of a mobile terminal.

### BACKGROUND

With the development of mobile communication technology, mobile terminals such as smart phones, become more and more important in our daily life. Accordingly, various applications are developed for mobile terminals, such as playing music, games, and browsing a website etc.

In the prior art, when a user wants to perform a certain operation of an application in a mobile terminal, for example, the user wants to send a message to his friend, several steps need to be performed as follows: at first, the user needs to find and open the “message” application; next the user chooses the “create new message” option; after opening the “create new message” interface, the user has to query and choose his friend's phone number from the phone book; then the user can edit a message and send it to his friend.

In today's fast-paced era, so many steps of operating each application make the operations of the applications inconvenient, thereby reducing the efficiency and usability of the mobile terminals, and wasting time.

### SUMMARY

Embodiments of the present invention provide a method and a device for processing an application of a mobile terminal, which can improve efficiency and usability of a mobile terminal.

To achieve the above object, embodiments of the present invention adopt the following technical solutions:

One aspect of the present invention provides a method for processing an application of a mobile terminal, including: generating a display interface, where the display interface includes a user habit list, the user habit list includes at least one user habit option, and the user habit option includes application information and content information; receiving a first operating command input by a user, and determining the user habit option corresponding to the first operating command; and triggering an application indicated by the application information of the user habit option which corresponds to the first operating command to parse the content information of the user habit option which corresponds to the first operating command, so as to make the application run content corresponding to the content information.

Before the generating the display interface, the abovementioned method further includes: receiving a second operating command input by the user, and determining the application corresponding to the second operating command; receiving a third operating command input by the user, and determining the content corresponding to the third operating command; updating a user habit statistical table according to the application corresponding to the second operating command and the content corresponding to the third operating command, where at least one piece of user habit information and number of use corresponding to the user habit information are recorded in the user habit statistical table, the user habit information includes the application information and the content information; and generating the user habit list according to the user habit statistical table.

In the abovementioned method, the generating the user habit list according to the user habit statistical table, specifically is: selecting a preset amount of the user habit information upon the number of use descending, and generating the user habit list according to the selected user habit information. The abovementioned method further includes: clearing content of the user habit statistical table in a preset time period. In the abovementioned method, the updating the user habit statistical table according to the application corresponding to the second operating command and the content corresponding to the third operating command, includes: determining the user habit information to be processed according to the application corresponding to the second operating command and the content corresponding to the third operating command; and judging whether the user habit information to be processed exists in the user habit statistical table, if so, increasing the number of use which corresponds to the user habit information to be processed in the user habit statistical table by 1, and if not, adding the user habit information to be processed to the user habit statistical table, and setting the number of use which corresponds to the user habit information to be processed to 1.

In the abovementioned method, the generating the user habit list according to the user habit statistical table, specifically is: dividing all the user habit information in the user habit statistical table into at least two categories according to an application type, where the application type is a type of the application; and in each category, selecting a preset amount of the user habit information upon the number of use descending, and generating the user habit list according to the selected user habit information. In the abovementioned method, the user habit statistical table includes at least two user habit statistical sub-tables, at least one piece of user habit information and number of use corresponding to the user habit information are recorded in each of the user habit statistical sub-tables, the user habit information includes the application information and the content information; the updating the user habit statistical table according to the application corresponding to the second operating command and the content corresponding to the third operating command, specifically is: determining occurrence time of the third operating command, determining one user habit statistical sub-table from the at least two user habit statistical sub-table, and updating the determined user habit statistical sub-table according to the application corresponding to the second operating command and the content corresponding to the third operating command; the generating the user habit list according to the user habit statistical table, specifically is: generating the user habit list according to the at least two user habit statistical sub-tables.

Another aspect of the present invention provides a device for processing an application of a mobile terminal, including: a generating module, configured to generate a display interface, where the display interface includes a user habit list, the user habit list includes at least one user habit option, and the user habit option includes application information and content information; a receiving module, configured to receive a first operating command input by a user; a determining module, configured to determine the user habit option corresponding to the first operating command; and a triggering module, configured to trigger an application indicated by the application information of the user habit option which corresponds to the first operating command to parse the content information of the user habit option which corresponds to the first operating command, so as to make the application run content corresponding to the content information.

In the abovementioned device, the receiving module is further configured to receive a second operating command and a third operating command input by the user; the determining module is further configured to determine the application corresponding to the second operating command, and determine the content corresponding to the third operating command;

The abovementioned device further includes: an updating module, configured to update a user habit statistical table according to the application corresponding to the second operating command and the content corresponding to the third operating command, where at least one piece of user habit information and number of use corresponding to the user habit information are recorded in the user habit statistical table, the user habit information includes the application information and the content information; the generating module is further configured to generate the user habit list according to the user habit statistical table.

In the abovementioned device, the generating module is specifically configured to select a preset amount of the user habit information upon the number of use descending, and generate the user habit list according to the selected user habit information. The abovementioned device further includes: a clearing module, configured to clear content of the user habit statistical table in a preset time period. In the abovementioned device, the updating module is specifically configured to: determine the user habit information to be processed according to the application corresponding to the second operating command and the content corresponding to the third operating command; and judge whether the user habit information to be processed exists in the user habit statistical table, if so, increase the number of use which corresponds to the user habit information to be processed in the user habit statistical table by 1, and if not, add the user habit information to be processed to the user habit statistical table, and set the number of use which corresponds to the user habit information to be processed to 1.

In the abovementioned device, the generating module is specifically configured to: divide all the user habit information in the user habit statistical table into at least two categories according to an application type, where the application type is a type of the application; and in each category, select a preset amount of the user habit information upon the number of use descending, and generate the user habit list according to the selected user habit information.

In the abovementioned device, the user habit statistical table includes at least two user habit statistical sub-tables, at least one piece of user habit information and number of use corresponding to the user habit information are recorded in each of the user habit statistical sub-tables, the user habit information includes the application information and the content information; the updating module is specifically configured to determine occurrence time of the third operating command, determine one user habit statistical sub-table from the at least two user habit statistical sub-table, and update the determined user habit statistical sub-table according to the application corresponding to the second operating command and the content corresponding to the third operating command; the generating module is specifically configured to generate the user habit list according to the at least two user habit statistical sub-tables.

By adopting the method and the device for processing the application of the mobile terminal according to embodiments of the present invention, the number of steps to operate specific content of an application in the mobile terminal is reduced to only one step through generating a display interface which includes a user habit list and triggering the application to run specific content thereof by only one operating command, thereby improving the efficiency and usability of the mobile terminals, and saving time.

### BRIEF DESCRIPTION OF THE DRAWINGS

To illustrate the technical solutions according to embodiments of the present invention or in the prior art more clearly, the accompanying drawings needed for describing the embodiments or the prior art are introduced below briefly. Apparently, the accompanying drawings in the following descriptions merely show some of the embodiments of the present invention, and persons of ordinary skill in the art can obtain other drawings according to the accompanying drawings without creative efforts.

FIG. 1 is a flowchart of a method for processing an application of a mobile terminal according to an embodiment of the present invention;

FIG. 2 is a flowchart of a method for processing an application of a mobile terminal according to anther embodiment of the present invention;

FIG. 3 is a schematic diagram of a user habit list according to an embodiment of the present invention;

FIG. 4 is a schematic diagram of a user habit list in a categorized view according to an embodiment of the present invention;

FIG. 5 is a schematic structural diagram of a device for processing an application of a mobile terminal according to an embodiment of the present invention; and

FIG. 6 is a schematic structural diagram of a device for processing an application of a mobile terminal according to another embodiment of the present invention.

### DETAILED DESCRIPTION OF ILLUSTRATIVE EMBODIMENTS

The technical solutions in the embodiments of the present invention are described clearly and comprehensively with reference to the accompanying drawings. Obviously, the embodiments described are only a part of embodiments of the present invention, not all embodiments. All other embodiments obtained by persons of ordinary skill in the art on the basis of the embodiments herein without any creative effort fall within the protection scope of the present invention.

The term “mobile terminal” as used in this application may be a mobile phone (or referred to as a “honeycomb” telephone) and a computer provided with a mobile terminal, for example, a portable, pocket, hand-held or vehicle-mounted mobile device, but not limited to these.

### Embodiment 1

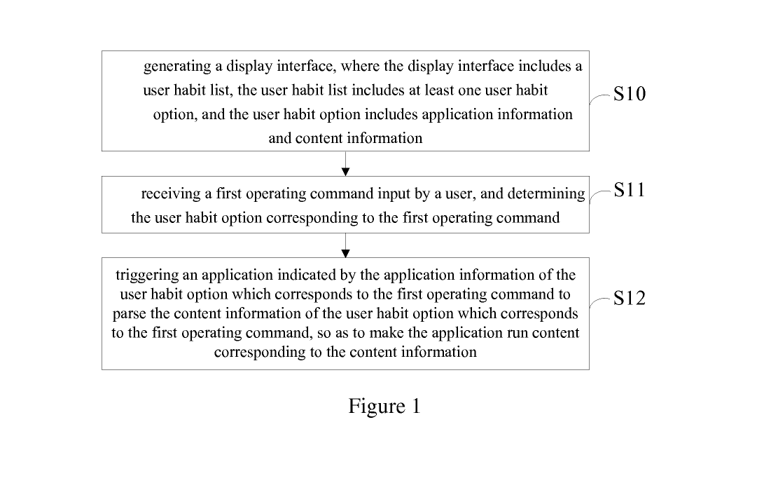

FIG. 1 is a flowchart of a method for processing an application of a mobile terminal according to an embodiment of the present invention. As shown in FIG. 1, the method includes: S10, generating a display interface, where the display interface includes a user habit list, the user habit list includes at least one user habit option, and the user habit option includes application information and content information;

Generally, a normal user of a mobile terminal such as smart phone uses only a set of operations in the smart phone regularly, even though there are a huge number of applications installed in the phone. For example, the user makes a call to his mom in the morning; the user browses “news.bbc.co.uk” website five times a day; the user sends messages to one or two of his friends regularly; the user listens to a specific FM radio channel regularly; the user plays a specific game regularly. All above operations form a part of this user's habits.

The display interface can be generated as a widget on the main screen of the smart phone, or as an ordinary application listed in the application menu of the smart phone, but not limit to these. The display interface includes the user habit list, where the user habit list is formed of at least one user habit option. The user habit list can be achieved as a linked list, an array, etc. The user habit option can be generated according to the abovementioned user's habits, for example, a user habit option may be “call mom”, and another user habit option may be “open http://news.bbc.co.uk”, etc. The user habit option can be generated automatically, that is, the user's habits of operating applications can be recorded based on frequency of the user's operations, and then the operations of specific content can be listed on the user habit list as user habit options. Optionally, the user habit option can also be added to the user habit list manually by choice of the user. Specifically, the user habit option includes application information and content information. The application information can specifically be an application index number, such as the name of the application or the identity (ID) of the application, which provides access to this application. The content information contains specific content of this application, where the specific content is operated by the user regularly in accordance with the user's habits, that is, the content information provides access to the specific content of the application.

S11, receiving a first operating command input by a user, and determining the user habit option corresponding to the first operating command; After the display interface has been generated, such as on the main screen, the first operating command input by the user on the main screen can be received. The first operating command can be input via the touch screen or the keyboard of the smart phone. Then the user habit option corresponding to the first operating command can be determined. For example, when the user clicks the “call mom” option on the user habit list of the display interface, it can be determined that the user habit option corresponding to this first operating command is the “call mom” option, which means that the user wants to call his mom through this operation. Further, the application information and the content information of this user habit option can be obtained.

S12, triggering an application indicated by the application information of the user habit option which corresponds to the first operating command to parse the content information of the user habit option which corresponds to the first operating command, so as to make the application run content corresponding to the content information. After obtaining the application information and the content information of the user habit option which corresponds to the first operating command input by the user, the application indicated by the application information (such as the application ID) is triggered to parse the specific content which the user wants to operate according to the content information. This step can be achieved through existing methods in the prior art, for example, Android platform uses “Intent” mechanism to drive all event triggers (such as making a call, sending a message etc). The information in Android ecosystem includes the application package (used to identify the application), the intent action (such as making a call, sending a message, opening a browser etc) and the data specific to the operation (such as a phone number for calling, a phone number for sending the message, a website for browsing etc). Hence, through this “Intent” mechanism, the specific content of the application can be accessed according to the application information and the content information. That is, the user only needs to input a first operating command corresponding to a user habit option when the user wants to operate specific content of an application which is listed on the display interface, and then the specific content can be accessed directly, without the need of performing several steps to access it.

By adopting the method for processing the application of the mobile terminal of this embodiment, the number of steps to operate specific content of an application in the mobile terminal is reduced to only one step through generating a display interface which includes a user habit list and triggering the application to run specific content thereof by only one operating command, thereby improving the efficiency and usability of the mobile terminals, and saving time.

### Embodiment 2

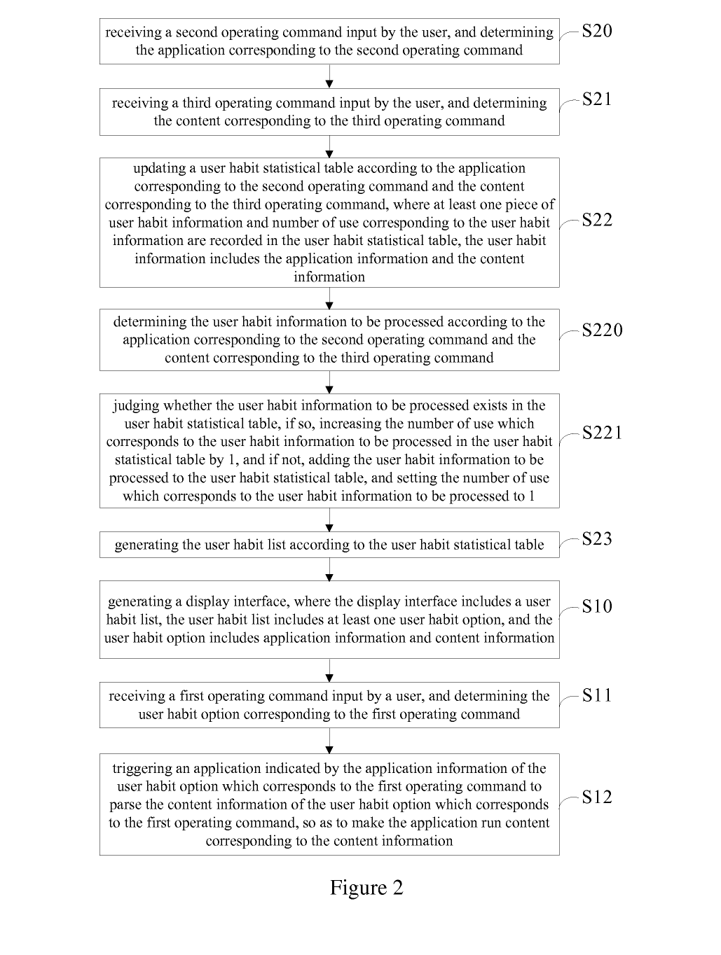

FIG. 2 is a flowchart of a method for processing an application of a mobile terminal according to anther embodiment of the present invention. As shown in FIG. 2, before generating a display interface, the aforementioned method further includes:

S20, receiving a second operating command input by the user, and determining the application corresponding to the second operating command; This embodiment describes in detail how to generate a user habit list according to a user's habits and update the user habit list in real time. First, the second operating command input by the user is received. The second operating command can be input via the touch screen or the keyboard of the smart phone. Specifically, the second operating command can be a command of opening an application. Accordingly, the application corresponding to the second operating command can be determined. For example, when the user clicks the “message” application on the application menu of the smart phone, it can be determined that the application corresponding to this second operating command is the “message” application. Specifically, since each application uses a common communication method to send its usage information, where the common communication method is such as the broadcasting mechanism used in the Android platform, and the usage information contains the application information and the content information needed in the present invention, the information of operating the application can be captured through such a mechanism when the application is operated by the user through the second operating command.

S21, receiving a third operating command input by the user, and determining the content corresponding to the third operating command; After entering the interface of the application corresponding to the second operating command, the user will input the third operating command to operate the specific content of this application. Now, the third operating command input by the user can be received. Also, the third operating command can be input via the touch screen or the keyboard of the smart phone. Specifically, the third operating command can be a command of performing a specific operation on the application. Accordingly, the content corresponding to the third operating command can be determined. For example, after entering the interface of the “message” application, the user clicks the “create new message” option on the interface, it can be determined that the content corresponding to this third operating command is the “create new message” option. Specifically, the information of operating the content of the application can also be captured through the common communication method when the specific content is operated by the user through the third operating command.

S22, updating a user habit statistical table according to the application corresponding to the second operating command and the content corresponding to the third operating command, where at least one piece of user habit information and number of use corresponding to the user habit information within a period of time (for example, one or two weeks from the updating date) are recorded in the user habit statistical table, the user habit information includes the application information and the content information;

The user habit statistical table is a table which records the information reflecting the user's habits. The user habit statistical table can be achieved as a linked list, an array, a matrix etc. At least one piece of the user habit information is recorded in the user habit statistical table, where the user habit information includes the application information and the content information described above, which will not be repeated here. Additional, the number of use corresponding to the user habit information is also recorded in the user habit statistical table. For example, if the user habit information is the information of opening the “http://news.bbc.co.uk”, and the user has browsed this website for five times, the number of use corresponding to this piece of the user habit information is recorded as “five times”. Preferably, the number of use can further include the occurrence time of each operation, and so on. It can be understood that, each time the user inputs a second operating command and a third operating command, it means that the number of use corresponding to the user habit information determined from the second and third operating command is changed. And now the user habit statistical table can be updated according to the application corresponding to the second operating command and the content corresponding to the third operating command.

Specifically, the updating the user habit statistical table according to the application corresponding to the second operating command and the content corresponding to the third operating command, includes: S220, determining the user habit information to be processed according to the application corresponding to the second operating command and the content corresponding to the third operating command;

After receiving the second operating command and the third operating command input by the user, as mentioned above, the application corresponding to the second operating command and the content corresponding to the third operating command can be determined. That is, the application information and the content information which form the user habit information can be obtained. And then the user habit information is determined as to be processed.

S221, judging whether the user habit information to be processed exists in the user habit statistical table, if so, increasing the number of use which corresponds to the user habit information to be processed in the user habit statistical table by 1, and if not, adding the user habit information to be processed to the user habit statistical table, and setting the number of use which corresponds to the user habit information to be processed to 1.

Before being updated, the user habit statistical table needs to be looked up, so as to judge whether the user habit information to be processed has been recorded in the user habit statistical table. If it has been recorded, that is, the user habit information exists in the user habit statistical table, only thing to do is increasing the number of use which corresponds to the user habit information to be processed by 1. Otherwise, if there is no such information in the user habit statistical table, which means that the operation corresponding to the information is performed by the user first time, the user habit information to be processed is added to the user habit statistical table and the number of user thereof is set to 1.

S23, generating the user habit list according to the user habit statistical table. After the user habit statistical table is updated each time, the user habit list can be generated according to the user habit information and the number of use thereof which are recorded in the user habit statistical table. Each piece of the user habit information can be set as a user habit option, and more than one user habit options corresponding to more than one pieces of the user habit information can be listed on the user habit list in a certain order, where the order is set according to the number of use.

Specifically, the generating the user habit list according to the user habit statistical table is: selecting a preset amount of the user habit information upon the number of use descending, and generating the user habit list according to the selected user habit information.

In practical use, the number of use should not be increased indefinitely. The following describes a preferable embodiment of recording the number of use of the user habit information, which can be called “Aggregation mechanism”: all user habit information can be recorded in the user habit statistical table and be maintained therein for one month; each piece of the user habit information is given a priority based on the number of use and the last occurrence time; and the priority can be set as follows: 1) if the user adds a certain operation to the user habit list manually, the user habit information corresponding to this operation has a first priority; 2) if the user has performed a certain operation frequently in the last two days, such as eight times, the user habit information corresponding to this operation has a second priority; 3) if the user has performed a certain operation in the last eight days and the number of use thereof is more, such as ten times in the last eight days but less than eight times in the last two days, the user habit information corresponding to this operation has a third priority; and 4) others can have a fourth priority. Where the first priority is the highest priority, the fourth priority is the lowest priority, and so forth.

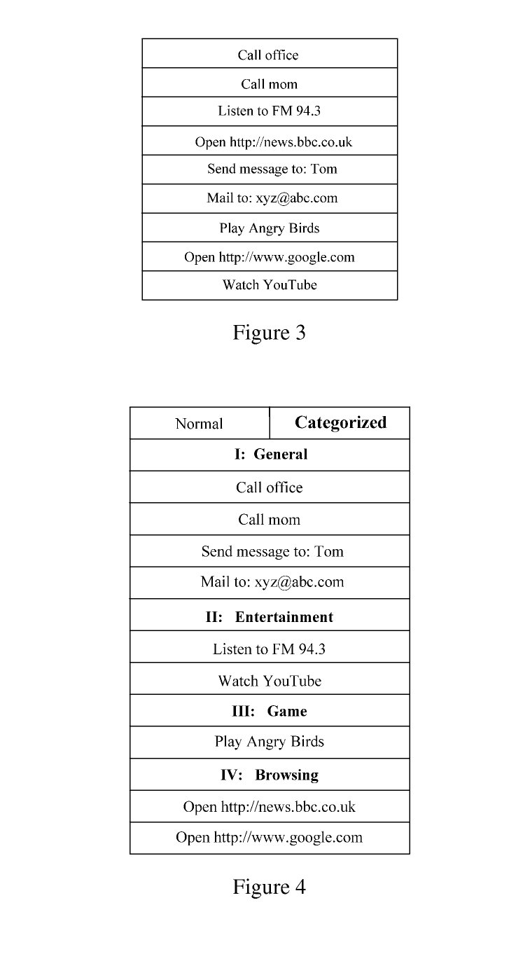

Through the “Aggregation mechanism”, a preset amount of the user habit information can be selected and listed on the user habit list based on the priorities high to low, that is, any piece of the user habit information with the first priority is higher on the list than any of the information with the second priority. For each kind of priorities, the user habit information can be selected and listed on the user habit list based on the number of use descending. In this way, the user habit list according to the selected user habit information is generated with the user habit information used most frequently on the top. FIG. 3 is a schematic diagram of a user habit list according to an embodiment of the present invention. As shown in FIG. 3, the user habit option “call office” has a highest priority, which means that the user calls his office most frequently. It should be understood that the preset amount can be set to a fixed value such as six, or can be set according to the priorities, for example, all the information with the first or the second priority is selected, in this case the number of the user habit options listed on the user habit list is variable.

After the user habit list of the display interface is generated, the first operating command can be received. The specific process of processing the first operating command is the same as the method for processing the application of the mobile terminal according to the foregoing embodiment of the present invention, which will not be repeated here.

By adopting the method for processing the application of the mobile terminal of this embodiment, the user habit information of operating specific content of an application in the mobile terminal can be obtained, and can also be aggregated and listed on the user habit list according to their number of use, so as to access the specific content of the application directly. Further, the user habit list is continuously updated so that changes in user's habits can be reflected on the user habit list dynamically. In this way, the efficiency and usability of the mobile terminals are improved, and the user can access his regularly used operations fast and conveniently.

Optionally, the user habit option can also be added to the user habit list manually. When the user performs a specific operation on an application, a “My Habit” option can be displayed on the operated page, so that the user can mark this specific operation as a user habit option through choosing this option. Once the user chooses the option displayed on a certain operated page of an application, the user habit option corresponding to this operation can be added to the user habit List directly without being aggregated by the “Aggregation mechanism”, and listed on the top of the user habit list with a priority higher than the first priority. For example, for the user habit list shown in FIG. 3, when the user is calling his friend Tom, the “My Habit” option will be displayed on the calling page. If the user chooses this option at the moment, the user habit option “Call Tom” is added to the user habit list and higher than the option “Call office” on the list. Next time the user wants to call Tom, it can be achieved directly by selecting the option “Call Tom” on the user habit list. It should be noted that the user habit option added manually will not be removed from the user habit list until the user removes it explicitly.

Optionally, in the above embodiments of the present invention, the aforementioned method further includes: clearing content of the user habit statistical table in a preset time period. The content of the user habit statistical, that is, the user habit information and the number of use thereof, can be cleared in a preset time period, so as to avoid wasting space of the mobile terminal.

### Embodiment 3

In the method for processing the application of the mobile terminal according to the above embodiments of the present invention, the generating the user habit list according to the user habit statistical table, specifically is: dividing all the user habit information in the user habit statistical table into at least two categories according to an application type, where the application type is a type of the application;

There are a variety of applications with various application types in the smart phone, which can be classified into several categories, such as “game”, “entertainment”, “browsing”, etc. All the user habit information in the user habit statistical table can be divided into at least two categories, that is, each piece of the user habit information can be classified into a certain category. Accordingly, the user habit list can support following different views: one is a normal view, in this case, all categories of the user habit options are listed on the user habit list according to the mode described above; the other is a categorized view, in this case, the user habit options are listed based on different categories. In each category, selecting a preset amount of the user habit information upon the number of use descending, and generating the user habit list according to the selected user habit information.

Specifically, in each category, the user habit options of this category are listed in the order similar to the order of the user habit options in the normal view. FIG. 4 is a schematic diagram of a user habit list in a categorized view according to an embodiment of the present invention. In this case, if the “normal” view is selected, the user habit options are listed just as shown in FIG. 3; if the “categorized” view is selected, the user habit list is displayed as shown in FIG. 4. Where, the option “Open http://news.bbc.co.uk” has a higher priority than the option “Open http://www.google.com”, which means that the user browses the former more frequently. In this way, when the user wants to visit a website which he used to visit, the user can look for this option under the “browsing” category; when the user wants to call his mom which he frequently does, the user can look for this option under the “general” category; and when the user wants to play a game which he played regularly, the user can look for this option under the “game” category.

By adopting the method for processing the application of the mobile terminal of this embodiment, the user habit information is divided into at least two categories according to the type of the application, the user can access his regularly used operations more easily, thereby the efficiency and usability of the mobile terminals are further improved.

### Embodiment 4

In the method for processing the application of the mobile terminal according to the above embodiments of the present invention, the aforementioned user habit statistical table can includes at least two user habit statistical sub-tables, at least one piece of user habit information and number of use corresponding to the user habit information are recorded in each of the user habit statistical sub-tables, the user habit information includes the application information and the content information;

In practice, the user may perform certain mobile operations only at particular time of the day, such as the user calls to his mom every day morning, or browses a stock website in the afternoon break every day. In this embodiment, at least two user habit statistical sub-tables are generated. Different from the above embodiments, when the user performs an operation on specific content of an application, not only the application information and the content information are obtained through a common communication method, but also the occurrence time of this operation is obtained. The user habit statistical sub-tables are generated according to the number of use of each specific operation of the application, as well as the occurrence time of the operation. For example, one user habit statistical sub-table can be a daytime sub-table including the user habit information corresponding to all the operations which occur at daytime (such as from 8:00 to 18:00), and the other habit statistical sub-table can be a nighttime sub-table including the user habit information corresponding to all the operations which occur at night (such as from 18:00 to 8:00).

Accordingly, the updating the user habit statistical table according to the application corresponding to the second operating command and the content corresponding to the third operating command, specifically is: determining occurrence time of the third operating command, determining one user habit statistical sub-table from the at least two user habit statistical sub-table, and updating the determined user habit statistical sub-table according to the application corresponding to the second operating command and the content corresponding to the third operating command;

Specifically, when receiving the third operating command input by the user, the occurrence time of the third operating command is determined at the same time when the content corresponding to the third operating command is determined. Then one user habit statistical sub-table can be determined according to the occurrence time. For example, when the occurrence time of the third operating command is 16:00, the daytime sub-table is determined. And then this determined user habit statistical sub-table is updated according to the application corresponding to the second operating command and the content corresponding to the third operating command. The updating process is the same as the process of updating the user habit statistical table in embodiment 2, which will not be repeated here.

Accordingly, the generating the user habit list according to the user habit statistical table, specifically is: generating the user habit list according to the at least two user habit statistical sub-tables.

Since the user habit statistical sub-tables list the user habit options based on time, the user habit list is changed upon time. For example, at daytime, the user habit list is generated by the daytime sub-table, that is, the user habit options which the user often performs at daytime are displayed on the user habit list at daytime, and at night, it is generated by the nighttime sub-table, that is, the user habit options which the user often performs at night are displayed on the user habit list at night.

By adopting the method for processing the application of the mobile terminal of this embodiment, the user habit list is changed and updated based on time, and then the user can access his regularly used operations more easily, thereby the efficiency and usability of the mobile terminals are further improved.

It should be noted that, in above embodiments of the present invention, when a first operating command is received, the specific content of an application is also operated through the method for processing the application of the mobile terminal according to the present invention. At the moment, the number of use corresponding to this user habit option should also be increased by 1 and the user habit list should be updated accordingly.

### Embodiment 5

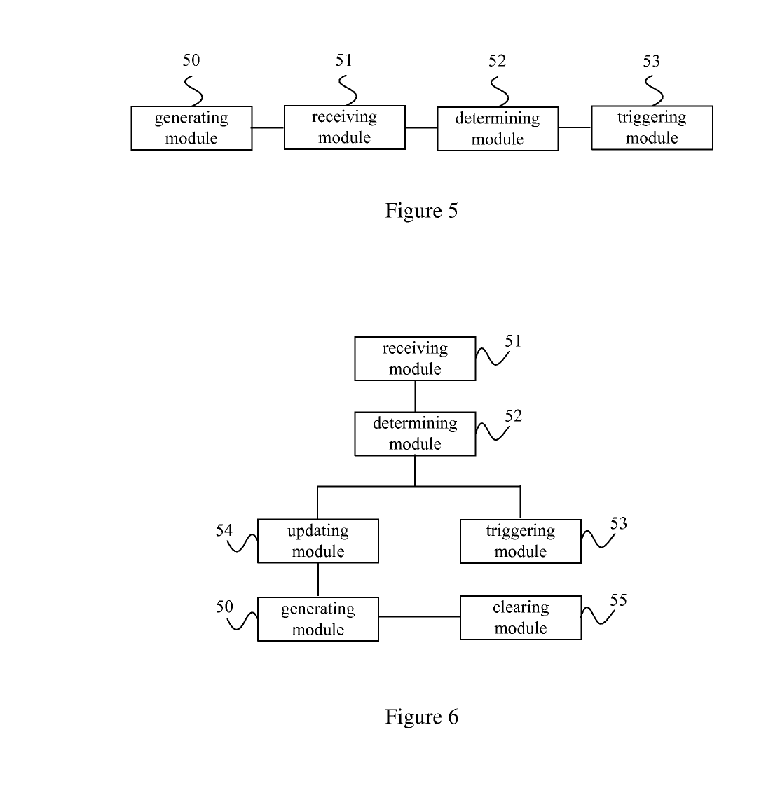

FIG. 5 is a schematic structural diagram of a device for processing an application of a mobile terminal according to an embodiment of the present invention. The device for processing the application of the mobile terminal according to this embodiment can implement the method for processing the application of the mobile terminal according to any one of embodiments of the present invention, but not limit to this. As shown in FIG. 5, the device includes a generating module 50, a receiving module 51, a determining module 52 and a triggering module 53. The generating module 50 is configured to generate a display interface, where the display interface includes a user habit list, the user habit list includes at least one user habit option, and the user habit option includes application information and content information. The receiving module 51 is configured to receive a first operating command input by a user. The determining module 52 is configured to determine the user habit option corresponding to the first operating command. And the triggering module 53 is configured to trigger an application indicated by the application information of the user habit option which corresponds to the first operating command to parse the content information of the user habit option which corresponds to the first operating command, so as to make the application run content corresponding to the content information.

The specific process of executing the method by the device of this embodiment is the same as the method for processing the application of the mobile terminal according to abovementioned embodiments of the present invention, which will not be repeated here.

By adopting the device for processing the application of the mobile terminal of this embodiment, the number of steps to operate specific content of an application in the mobile terminal is reduced to only one step through generating a display interface which includes a user habit list by the generating module 50 and triggering the application by the triggering module 53 to run specific content which is determined by the determining module 52, all above are achieved through only one operating command received by the receiving module 51, thereby improving the efficiency and usability of the mobile terminals, and saving time.

### Embodiment 6

FIG. 6 is a schematic structural diagram of a device for processing an application of a mobile terminal according to another embodiment of the present invention. As shown in FIG. 6, in this embodiment, the receiving module 51 is further configured to receive a second operating command and a third operating command input by the user; and the determining module 52 is further configured to determine the application corresponding to the second operating command, and determine the content corresponding to the third operating command.

Further, the device of this embodiment further includes an updating module 54, the updating module 54 is configured to update a user habit statistical table according to the application corresponding to the second operating command and the content corresponding to the third operating command, where at least one piece of user habit information and number of use corresponding to the user habit information are recorded in the user habit statistical table, the user habit information includes the application information and the content information.

Accordingly, the generating module 50 is further configured to generate the user habit list according to the user habit statistical table. Specifically, the generating module 50 is specifically configured to select a preset amount of the user habit information upon the number of use descending, and generate the user habit list according to the selected user habit information. Further, the device of this embodiment further includes a clearing module 55, the clearing module 55 is configured to clear content of the user habit statistical table in a preset time period.

Specifically, the updating module is configured to: determine the user habit information to be processed according to the application corresponding to the second operating command and the content corresponding to the third operating command; and judge whether the user habit information to be processed exists in the user habit statistical table, if so, increase the number of use which corresponds to the user habit information to be processed in the user habit statistical table by 1, and if not, add the user habit information to be processed to the user habit statistical table, and set the number of use which corresponds to the user habit information to be processed to 1.

Specifically, the generating module is configured to divide all the user habit information in the user habit statistical table into at least two categories according to an application type, where the application type is a type of the application; and in each category, select a preset amount of the user habit information upon the number of use descending, and generate the user habit list according to the selected user habit information.

In the device of this embodiment, the user habit statistical table includes at least two user habit statistical sub-tables, at least one piece of user habit information and number of use corresponding to the user habit information are recorded in each of the user habit statistical sub-tables, the user habit information includes the application information and the content information.

Specifically, the updating module is configured to determine occurrence time of the third operating command, determine one user habit statistical sub-table from the at least two user habit statistical sub-table, and update the determined user habit statistical sub-table according to the application corresponding to the second operating command and the content corresponding to the third operating command.

Specifically, the generating module is configured to generate the user habit list according to the at least two user habit statistical sub-tables.

The device for processing the application of the mobile terminal according to this embodiment can implement the method for processing the application of the mobile terminal according to any one of embodiments of the present invention, the specific process of executing the method by the device of this embodiment is the same as the method for processing the application of the mobile terminal according to abovementioned embodiments of the present invention, which will not be repeated here.

By adopting the device for processing the application of the mobile terminal of this embodiment, the user habit information of operating specific content of an application in the mobile terminal can be obtained through the receiving module 51 and the determining module 52, and can also be aggregated and listed on the user habit list according to their number of use, so as to access the specific content of the application directly. Meanwhile, the user habit list is continuously updated through the updating module 54 so that changes in user's habits can be reflected on the user habit list dynamically. And through the user habit information being divided into at least two categories, the user can access his regularly used operations more easily. Additional, the user habit list can also be changed and updated based on time. In this way, the efficiency and usability of the mobile terminals are further improved, and the user can access his regularly used operations fast and conveniently.

Those skilled in the art may understand that all or part of the steps in the methods of the embodiments can be implemented by hardware under the instruction of a program. The program may be stored in a computer readable storage medium and when the program is executed, the steps in the methods of the embodiments are executed. The storage medium may be any medium that can store a program code, including ROM, RAM, a magnetic disk, or a Compact Disk-Read Only Memory, etc.

The above mentioned are only specific embodiments of the present invention, however the scope of the present invention is not limited to this, modifications or replacements can be easily thought of within the scope of the present invention by any technical person familiar with the art, all of which should fall within the scope of the present invention.

What is claimed is:

1. A method for processing an application of a mobile terminal, comprising:
generating a display interface comprising a user habit list, the user habit list including at least one user habit option that comprises application information and content information, wherein the application information indicates an application for parsing the content information;
receiving a first operating command input by a user;
determining that the user habit option corresponds to the first operating command; and
triggering the application to parse the content information of the user habit option corresponding to the first operating command, wherein the triggering the application to parse the content information prompts the application to run content corresponding to the content information.

2. The method according to claim 1, wherein before the generating the display interface, the method further comprises:
receiving a second operating command input by the user;
determining that the application corresponds to the second operating command;
receiving a third operating command input by the user;
determining that the content corresponds to the third operating command;
updating a user habit statistical table according to the application corresponding to the second operating command and the content corresponding to the third operating command, wherein the user habit statistical table associates user habit information with number of use parameter corresponding to a frequency in which the associated user habit information has been used by the user during a preset time period, and wherein the user habit information comprises the application information and the content information; and
generating the user habit list according to the user habit statistical table.

3. The method according to claim 2, wherein generating the user habit list according to the user habit statistical table comprises:
selecting a preset amount of the user habit information in accordance with a descending order of the number of use parameters such that user habit information that has been used more frequently is selected prior to user habit information that has been used less frequently; and
generating the user habit list according to the selected user habit information.

4. The method according to claim 2, further comprising:
clearing content from the user habit statistical table at the end of the preset time period.

5. The method according to claim 2, wherein updating the user habit statistical table according to the application corresponding to the second operating command and the content corresponding to the third operating command comprises:
determining that the user habit information is to be processed according to the application corresponding to the second operating command and the content corresponding to the third operating command;
judging whether the user habit information to be processed was stored in the user habit statistical table prior to receiving the third operating command;
incrementing a number of use parameter corresponding to the user habit information to be processed in the user habit statistical table when the user habit information to be processed was stored in the user habit statistical table prior to receiving the third operating command; and
adding the user habit information to be processed to the user habit statistical table, and setting a number of use parameter corresponding to the user habit information to be processed to one when the user habit information to be processed was not stored in the user habit statistical table prior to receiving the third operating command.

6. The method according to claim 2, wherein generating the user habit list according to the user habit statistical table comprises:
dividing all the user habit information in the user habit statistical table into two or more categories according to an application type associated with the application;
selecting a preset amount of the user habit information for each of the two or more categories in accordance with a descending order of the number of use parameters; and
generating the user habit list according to the selected user habit information.

7. The method according to claim 2, wherein the user habit statistical table comprises at least two user habit statistical sub-tables each of which storing at least one piece of user habit information and a number of use parameter corresponding to the at least one piece of user habit information,
wherein updating the user habit statistical table according to the application corresponding to the second operating command and the content corresponding to the third operating command comprises determining an occurrence time of the third operating command, determining one user habit statistical sub-table from the at least two user habit statistical sub-tables, and updating the determined user habit statistical sub-table according to the application corresponding to the second operating command and the content corresponding to the third operating command, and
wherein generating the user habit list according to the user habit statistical table comprises generating the user habit list according to the at least two user habit statistical sub-tables.

8. A device for processing an application of a mobile terminal, comprising:
a processor; and
a computer readable storage medium storing programming for execution by the processor, the programming including instructions to:
generate a display interface comprising a user habit list, the user habit list including at least one user habit option that comprises application information and content information, wherein the application information indicates an application for parsing the content information;
receive a first operating command input by a user;
determine that the user habit option corresponds to the first operating command; and
trigger the application to parse the content information of the user habit option corresponding to the first operating command, wherein the triggering the application to parse the content information prompts the application to run content corresponding to the content information.

9. The device according to claim 8, wherein the programming further includes instructions to:
receive a second operating command input by the user;
determine that the application corresponds to the second operating command;
receive a third operating command input by the user;
determine that the content corresponds to the third operating command;
update a user habit statistical table according to the application corresponding to the second operating command and the content corresponding to the third operating command, wherein the user habit statistical table associates user habit information with number of use parameter corresponding to a frequency in which the associated user habit information has been used by the user during a preset time period, and wherein the user habit information comprises the application information and the content information; and
generate the user habit list according to the user habit statistical table prior to generating the display interface.

10. The device according to claim 9, wherein the instructions to generate the user habit list according to the user habit statistical table includes instructions to:
select a preset amount of the user habit information in accordance with a descending order of the number of use parameters such that user habit information that has been used more frequently is selected prior to user habit information that has been used less frequently; and
generate the user habit list according to the selected user habit information.

11. The device according to claim 9, wherein the programming further includes instructions to:
clear content from the user habit statistical table at the end of the preset time period.

12. The device according to claim 9, wherein the instructions to update the user habit statistical table according to the application corresponding to the second operating command and the content corresponding to the third operating command include instructions to:
determine that the user habit information is to be processed according to the application corresponding to the second operating command and the content corresponding to the third operating command;
judge whether the user habit information to be processed was stored in the user habit statistical table prior to receiving the third operating command;
increment a number of use parameter corresponding to the user habit information to be processed in the user habit statistical table when the user habit information to be processed was stored in the user habit statistical table prior to receiving the third operating command; and
add the user habit information to be processed to the user habit statistical table, and set a number of use parameter corresponding to the user habit information to be processed to one when the user habit information to be processed was not stored in the user habit statistical table prior to receiving the third operating command.

13. The device according to claim 9, wherein the instructions to generate the user habit list according to the user habit statistical table include instructions to:
divide all the user habit information in the user habit statistical table into two or more categories according to an application type associated with the application;
select a preset amount of the user habit information for each of the two or more categories in accordance with a descending order of the number of use parameters; and
generate the user habit list according to the selected user habit information.

14. The device according to claim 9, wherein the user habit statistical table comprises at least two user habit statistical sub-tables each of which storing at least one piece of user habit information and a number of use parameter corresponding to the at least one piece of user habit information,
wherein the instructions to update the user habit statistical table according to the application corresponding to the second operating command and the content corresponding to the third operating command include instructions to determine an occurrence time of the third operating command, to determine one user habit statistical sub-table from the at least two user habit statistical sub-tables, and to update the determined user habit statistical sub-table according to the application corresponding to the second operating command and the content corresponding to the third operating command, and
wherein the instructions to generate the user habit list according to the user habit statistical table includes instructions to generate the user habit list according to the at least two user habit statistical sub-tables.
